(19) United States
(12) Patent Application Publication
(10) Pub. No.: US 2023/0225288 A1
(43) Pub. Date: Jul. 20, 2023

(54) CLIPPING ACTUATOR

(71) Applicant: Safetypawz LLC, Oakton, VA (US)

(72) Inventors: Marcantonio Williams Barnes, Oakton, VA (US); Jackson Henry HEDDEN, Birmingham, AL (US)

(21) Appl. No.: 18/094,195

(22) Filed: Jan. 6, 2023

Related U.S. Application Data
(60) Provisional application No. 63/297,499, filed on Jan. 7, 2022.

(51) Int. Cl. A01K 13/00

(52) U.S. Cl. CPC A01K 13/00

(57) ABSTRACT

The present disclosure relates to an actuator including an armature with a cutting blade system and cutting blade that is useful in, for example, devices, systems, and methods for nail clipping especially in domestic animals. More specifically, the present disclosure relates to devices, systems, and methods for animal nail clipping that include the novel actuator of the invention.

### CROSS-REFERENCE TO RELATED APPLICATIONS

This application claims the benefit of U.S. provisional application No. 63/297,499, which was filed on Jan. 7, 2022 and is incorporated herein by reference in its entirety.

### FIELD OF THE INVENTION

The present disclosure relates to an actuator that is useful in, for example, devices, systems, and methods for nail clipping. More specifically, the present disclosure relates to devices, systems, and methods for animal nail clipping that include a novel nail clipping device including an actuator, armature/plunger including a blade carrier and a blade that provides sufficient force to safely clip a nail. In certain embodiments, the invention relates to devices, systems, and methods including a sensor and an actuator for safely clipping a nail.

### BACKGROUND OF THE INVENTION

Various animal nail clippers have been shown in the prior art such as U.S. Pat. No. 2,955,354, issued to Laing, and U.S. Pat. No. 3,838,507 issued to Clark, and U.S. Pat. No. 4,228,585, issued to Nelson. One of the deficiencies in prior art clippers is no provision for localizing the quick of the nail prior to clipping the nail thus avoiding injury.

The present invention overcomes this deficiency by providing a mechanically actuated nail clipper for an animal, or pet, which allows the user to sense the position of the quick prior to clipping the nail then to clip the nail safely at the desired length, with the push of a button, without having to manually cut or grind the nail.

Further, the U.S. Pat. No. 3,845,553 to Fields showed a claw clipper with a reciprocating cutter. The clipper has a gauge 56 to establish how much nail to remove. The reciprocating cutter, 30, then is rapidly advance to clip the nail using a motorized screw. The cutter includes a spring to return the cutter to a recoiled position for the motorized screw to advance the cutter again, reciprocally. Alas, this patent does not detect the presence of the quick with any sensor.

The published patent application to Kang, No. 2006/0042559 shows a clipper for pet claws with a lever operated cutter. The clipper receives a nail on the side and the nail proceeds between the two blades of the cutter. The cutter has a fixed blade and a rotating blade. Grasping the lever rotates the rotating blade to clip the nail. The application discloses a battery powered motor in the larger handle for grinding a clipped nail. The present invention though has a cutter that receives a nail from the bottom and a cutter with two blades. The blades of the present invention slide along a common line while abutting each other. The present invention lacks a motor or other grinding feature but does have the sensing means and quick indicator which further differentiates the present invention from the Kang publication.

The U.S. Pat. No. 7,000,321 to Rodgers discloses an optical source and corresponding sensor for detecting the quick of an animal's nail. This device has a manual clipper with a sliding blade coupled with an optical source and sensor. The source and sensor are mounted proximate the clipper so an accurate reading of light passing through a nail is ascertained by the sensor prior to usage of the clipper. In contrast, the present invention includes mechanical clipping actuator (MCA) including a sensor that provides sensing of the quick of an animal nail through electrical charge or capacitance or resistance, a thermocouple, piezo-electric, heat, ultrasound, x-ray radiation, and/or red, infrared, or near-infrared radiation. Once the quick is detected using the sensor, the present invention disables the button that provides electricity to activate the cutting action of the MCA, releasing the current only when the sensor detects the absence of quick in the claw.

The allowed patent application to Huggans, published as No. 2005/0132975, shows a hand powered nail and claw clipper. The clipper has a two blade guillotine type cutter where one blade is advanced along the other blade when the handle is closed. The clipper also has a sensor located in the fixed blade opposite the advancing other blade. The sensor is preferably a high intensity light with a cooperating detector or alternatively an ultrasound detector, a pulse oximeter, a laser, and an infrared thermometer. In contrast, the present invention has at least one LED to inform the operator visually, using single or multiple colors, about proximity to the quick and a detector capable of initializing itself. The detector establishes, or uses a pre-established, baseline on a non-quick substance, such as air, and uses that baseline to later determine the presence of: (i) keratin-only; or (ii) blood in the quick. An operator need not look at the position of the cutting blade on a nail but rather at the LED. In further contrast, if quick is detected by the sensor the instant invention disables the button that provides electricity to activate the cutting action of the MCA, releasing the current only when the sensor detects the absence of quick in the claw.

The present invention overcomes the limitations of the prior art where the animal nail clipper provides a sensing means coupled to a visual output to guide an operator in positioning the clipper upon an animal's nail for cutting without injuring the quick. The prior art cutters do not provide for guiding the cutter away from the quick but rather provide mere detection of the quick. Accordingly, the present invention overcomes the limitations of the prior art with (i) an electric cutting mechanism that uses novel power applications; and (ii) novel sensor technology that analyzes values that are distinct from the art.

### SUMMARY OF THE INVENTION

In certain embodiments, the invention encompasses a device for cutting nails of an animal, for example, a domestic animal such as a dog, cat, or the like.

In embodiments, the invention encompasses an actuator for use, for example, in a nail clipper. In various embodiments, devices, systems, and methods of the invention include: (i) an actuator; and (ii) a linear blade assembly that is mounted to the actuator that can be used, for example, in an animal nail clipper that may comprise: (a) a body for grasping by a user's hand; (b) the body defining a clip space as a space for insertion of an animal's nail for clipping; (c) at least one blade coupled with the body for movement between a withdraw position retracted from the clip space and a clip position extended into the clip space for clipping. In some embodiments, the clipper may include (d) a clipping control system including a sensor system for detecting non-nail material of an animal's nail within the clip space. The non-nail material of concern may include the quick of the animal's nail. The MCA may be arranged to produce an “oversized” force from a small actuator, enabling clipping-specific advantage (e.g., a small, portable, hand-held pet nail clipper that operates on battery power).

In certain embodiments, the invention encompasses an actuator that coverts electric current into mechanical motion of an armature (e.g., moveable plunger) with a force sufficient to clip a nail, for example, an animal's nail. In certain embodiments, the invention further includes a sensing device to identify the quick of an animal and allows actuation of the actuator and movement of the armature only when an animal's quick is not within a cutting area.

In other embodiments, the invention encompasses an animal nail clipper comprising at least one blade for cutting the nail, at least one sensor for identifying a portion of the nail, a processor that generates a signal from the sensor, which differentiates between a “quick” signal and a “nail” signal. The quick signal level arises from a living-tissue-containing portion of the animal nail, while the nail signal level arises from a portion of the nail substantially devoid of living tissue. An indicator activates the actuator, which of the quick signal level and the nail signal level (or some signal level between) is generated by the processor. Activation following the user depressing the “cut button” causes the cutting actuator to “throw” the armature plunger and attached moveable blade to a position relative to the sensor reading.

In certain embodiment, the invention encompasses a novel actuator that moves or “throws” an armature (i.e., plunger) comprising a cutting blade. In certain embodiments, the invention comprises an actuator that generates an oversized magnetic field that fully-engulfs a rod/plunger and drives or “throws” that rod forward at sufficient speed and force to cut a nail.

In certain embodiments, the actuator is designed to “throw” any object that is attached to the armature (e.g., a diamond-shaped cutting blade). As opposed to “holding” or “pushing/pulling” an object (as occurs in “actuators), the actuator moves to provide a cutting action at the force and speed sufficient to cut the nail of large and small animals. In certain embodiments, the actuator generates a large force (e.g., 15-20 pound-force), throwing an armature including a blade, which are both attached to the actuator, forward, which is then stopped by the walls of the magnetic field, never truly having a push-pull length. In certain embodiments, the magnetic field is pushed and contained by a ferromagnetic container, which allows the magnetic field to cover the entire armature/plunger. It was surprisingly found that there is a very large difference in size ratio, between the armature and the coil. The coil is about six larger than the rod indicating that the forces come mainly from the magnetic field.

In certain embodiments, the actuator includes a coil made to work in tandem with batteries (e.g., direct current) and their “influx” of power. In certain embodiments, the amps provided by the battery are put directly into the coil, instead of being limited by resistors and other electronic circuitry as more commonly found in other electronic devices. This influx is timed using a sensor and processor to be perfectly delivered exactly when it is needed, for example, at the cutting stroke. After the cut is completed, the influx fades, which allows the magnetic field to weaken throwing the rod more severely than what would be seen on direct/wall (DC) power.

The inventors have surprisingly found that there are several features that distinguish the instant actuator from other devices that are commonly known as actuators. First, the actuator is made exclusively for battery operation. The actuator is designed to throw the armature forward to allow the armature and blade to cut and then return to a rest position not to hold in the throw position. The actuator is designed not to have a full stopping point, but instead to spring back, using magnetic force. Finally, unlike other actuators, the current actuator does not have a mounting thread, rather the blade carrier is mounted to the frame of the actuator. The actuator thereby becomes a structural element of the cutting assembly. Finally, the frame of the actuator is specifically designed to be thicker in the back directing all the magnetic force forwards.

The claimed actuator including the blade carrier has advantages over known cutting systems serving similar functions, because known mechanical or electric clipping “concepts” are not commercially available (or viable) because the power requirements (needed to actually perform a cut with these other cutting concepts) would require so much space within those devices that the device loses the commercial convenience of a truly hand-held device. In contrast, the actuator and blade carrier of the present invention overcomes the size-challenge of existing conceptual devices. In addition, the actuator only requires about a 25 millisecond (ms) burst of power from a battery pack to create the force that “launches” the blade at high enough speeds to create enough power to cut a claw. That is unique and exclusive to the current invention and design. The design of the actuator within the current invention requires less power, and operates on a smaller battery solution, which results in a significantly smaller, commercially viable hand-held pet nail clipper. In various embodiments, the 25 ms burst would not work in prior art because of how they are designed. Specifically, the actuator of the current invention uses a magnetic field, and the conceptual designs in the art do not. Consequently, the conceptual designs in the art would require more power (and for much longer periods of time) than the MCA. The MCA design, the metallurgy of the MCA itself (which impacts the power of the magnetic field), along with how/when the current invention fires the electronics all offer several new and novel inventions. In other embodiments, the invention comprises a nail cutting composition including.

(a) a body for grasping by a user's hand;

(b) the body defining a clip space as a space for insertion of an animal's nail for clipping; and

(c) at least one blade coupled with the body for movement between a withdraw position retracted from the clip space and a clip position extended into the clip space for clipping.

The invention generally encompasses an animal nail trimming device which is capable of indicating the location of the nail quick, and therefore the blood supply and nerves in the nail, including a blade and an actuator that when engaged provides enough force to cut an animal nail. The invention encompasses an improved nail clipper for an animal, such as a dog or cat, that provides safety while clipping the animal's nails to prevent injury or harm to the animal.

Another embodiment encompasses a nail clipper with a sensor powered by batteries (i.e., direct current). In certain exemplary embodiments, the sensor includes a red, infrared or near-infrared sensor. In certain embodiments, the invention includes an actuator that provides enough internal force to activate the clipper to cut an animal nail.

The invention also includes a sensor that allows the user to identify a “safe position” in which an animal's nail is positioned in the correct position, which activates the blade to allow instant cutting of the nail to avoid cutting the nail too low and damaging the quick and causing injury to the animal.

In various embodiments, the invention includes a mechanical clipping actuator (MCA) for nail clipping, for example, of an animal. The devices, systems, and methods of the invention include (operation of): (i) an actuator; and (ii) a linear blade assembly that is mounted to the actuator and may be used in an application for an animal nail clipper that may comprise: (a) a body for grasping by a user's hand; (b) the body defining a clip space as a space for insertion of an animal's nail for clipping; (c) at least one blade coupled with the body for movement between a withdraw position retracted from the clip space and a clip position extended into the clip space for clipping. In some embodiments, the clipper may include (d) a clipping control system including a sensor system for detecting non-shell material of an animal's nail within the clip space. The non-shell material of concern may include the quick of the animal's nail. The MCA may be arranged to produce “oversize” force from a smaller actuator, enabling clipping-specific advantage (i.e., a small, portable, hand-held pet nail clipper that operates on battery power).

The essence of this invention provides a clipper for quick and safe sensing and locating the nail/claw for trimming an animal's claws and nails. The device and method of the invention identify the quick of the claw, advise a user whether the clipper could be safely activated, choosing the appropriate point for trimming said claw, and performing the cutting operation by activating the actuator with the blade.

In certain embodiments, the nail clipper includes a sensor, for example, an red, infrared, or near-infrared sensor, for identifying the quick of the nail and alerting the user when it is safe to clip the nail. The sensor returns a different signal response when positioned near air, nail, or nail overlaying quick. Thus, the internal structures of the nail, in particular the blood or living tissue of the quick, or the blood flow, can be localized in order to verify that the cut will be made in a safe place. The invention includes alternative sensors for detecting and localizing blood flow including, but not limited to, electrical resistance, Doppler ultrasound, commonly used for blood flow detection in humans, or laser imaging.

In various embodiments, the sensor takes advantage of the ability of live tissue portions of the claw (e.g., the quick) to absorb energy better than keratin-only segments (e.g., nail only). Because the actuator, which drives the armature including the blade, performs the cutting action by throwing a moving blade through the clip space, the live tissue-portions of the nail absorb more of this energy than the nail/keratin-only portions, and is therefore more difficult to cut than keratin only sections of the nail, adding an additional layer of safety/security for the user.

The invention comprises a clipper with a blade and optionally a sensor. The clipper is any of the variety of shearing or grinding processes accomplished within a hand-held device appropriate for selectively removing portions of the animal claws. The sensor is any of a variety of sensors, including, but not limited, to the following:

(1) transmitter/receiver sensors in which a sensible signal is transmitted though the claw and received on the other side of the claw by an appropriate means. Attenuation, phase change, capacitance change, conductivity, or any other change in the signal, attributable to the presence of the quick in the transmission path which differentiates transmission through claw and quick, is used to identify and localize the quick, thus guiding later trimming of the claw without injury to the quick. Such sensible signals include: red, infrared, or near-infrared light, x-ray radiation, visible light, heat, sound, electricity, electrical charge, and electrical fields.

(2) receiver sensors in which a naturally occurring characteristic of the internal structure of the nail is sensed and interpreted to localize the quick, guiding, further trimming of the claw without injury to it. Such receivable sensor detect body heat, blood flow sounds, transmitted ambient visible light, and reflected ambient visible light.

(3) receiver-less sensors impose a signal into or onto the claw and the user relies on their own senses to receive and interpret the resulting information to locate the quick for later trimming of the claw without injury to it. Such interpreted information includes: visible light, vibration, and heat.

In certain embodiments, the clipper is a hand-held and hand-powered cutting device. The sensor, for example, a red, infrared, or near-infrared sensor to identify the animal's quick and allow the user to activate the device in a safe manner. The sensor is mechanically joined to the clipper such that a constant and known geometry is maintained between the sensor means and the location where the cut will occur when the clipper is actuated.

In certain embodiments, the invention encompasses devices and methods in which a user switches the sensor circuit on. The user then positions the clipper means near the claw and receives an indication, for example, in the form of a pattern of colored lights that indicates the structure adjacent to the sensor means. The user then moves the clipper sensor assembly in a proximal direction along the nail until the light pattern indicates that the sensor detects the presence of quick in the cutting zone. The user then moves the clipper sensor assembly distally along the nail until the light pattern indicates the sensor detects only nail. Using the light pattern, the user adjusts the position of the clipper means to the desired trimming location while avoiding the quick. The clipper is then activated and the cut is made.

In certain embodiments, various LED colors can be used to prompt to user to take action (or refrain from attempting an action). Preferably only two LEDs are used green and red. If the red LED is lit, it indicates that quick is present near the sensor and by inference the clipping means is positioned so that it would cut through quick. Accordingly, if red is illuminated all electricity to the MCA is blocked, preventing the actuator from energizing the magnetic field which throws forward to moving blade, thereby avoiding injury to the animal. If the green LED is lit, it indicates that only nail material is present near the sensor, and the clipper means may safely cut. r. In an alternate embodiment, other light patterns can be used to communicate to the user, including an alphanumeric display, a bar type display, and a liquid crystal display among other things.

In certain embodiments, other light patterns, such as no LEDs lit or all LEDs, blinking indicate operational situations, such as low battery power or no material other than air in the vicinity of the sensor.

In various embodiments, the device and method of the invention include a nail clipper blade attached to an armature included in the actuator assembly that is powered by batteries or an external power coupled to the cutting blades. The sensor is powered externally or internally, the clipper includes a diamond-shaped blade, and may optionally further include a burr, or grinder to remove excess claw material. In various embodiments, the clipper includes a processor that automatically signals the actuator to move (or remain locked) to allow the clipper blade to engage for optimum trimming of the claw.

In certain embodiments, the clipper includes a visible or invisible radiation or energy source (e.g., red, infrared or near infrared radiation/energy) located inside the clipper proximate to where a nail is placed. A mounting point is included for a sensor appropriate to receive signal from the radiation source and return an electrical signal in response to the signal. Upon sensing the nail material the actuator is actuated by an electrical input signal. The radiation is communicated through the nail material and is received by the radiation sensor. The radiation sensor responds to the radiation by producing an electrical output signal. The electrical output signal is then communicated to an interpretation circuit. The attenuation of the electrical output signal when compared with open air attenuation can be interpreted as the opacity of the nail material. The interpretation of the opacity comprises a measurement means. The measurement means is then sensibly displayed as visual output by LED or audible output by beeper or horn. In all of the preceding embodiments the sensing means is considered to be predictably located with respect to the clipping plane of the blades, thereby allowing the user to use the output, visibly or audibly, as a cue to correctly position the clipping plane.

In another embodiment, the visible or invisible radiation sensor has sufficient luminosity to allow visualization of the interior structure of the nail material and avoidance of the quick. A light detecting receiver/sensor may be incorporated to allow detection of extremely low levels of transmitted light. An extremely fast electronic gate may also be used to select only those first few photons which reach the receiver as these photons went through a nail on the straightest path.

Other variations and modifications to the subject matter of this invention may be considered to those skilled in the art upon review of the invention as described herein. The ideas presented are not intended to limit the scope or application of the device, or its method of usage. Other objects, purposes, methods of usage, and variations may be considered by those skilled in the art.

### BRIEF DESCRIPTION OF THE FIGURES

FIG. 1 illustrates an exemplary nail clipper including a plunger encased in a housing including a mechanical cutting actuator when engaged allows the plunger to move a blade with enough force to cut a nail.

FIG. 2 illustrates an exemplary actuator with the armature/plunger assembly including the actuator tube housing and cutting blades.

FIG. 3 illustrates an exemplary embodiment of a plunger.

FIG. 4 illustrates an exemplary embodiment of the actuator tube housing.

FIG. 5 illustrates an exemplary embodiment of the spindale.

FIG. 6 illustrates an exemplary embodiment of the spring.

FIG. 7 illustrates an exemplary embodiment of the spindale and the coil.

FIG. 8 illustrates an exemplary embodiment of the cutting assembly and a cross-sectional view of the internal components.

FIG. 9 illustrates an exemplary cross-sectional view of the internal components of the nail clipper including a plunger encased in a housing including a mechanical cutting actuator when engaged allows the plunger to move a blade with enough force to cut a nail.

FIG. 10 illustrates an exemplary cutting device further illustrating the cutting assembly with a side view of the LED lighting strip, the cutting switch, and the on/off switch.

FIG. 11 illustrates the actuator located inside the cutting device, which includes the cutting assembly including a top cutting blade and a bottom cutting blade.

FIG. 12 illustrates exemplary embodiments of the actuator including the cutting assembly, wire, spring, and armature.

FIG. 13 illustrates exemplary embodiments of the plunger assembly.

FIG. 14 illustrates an exemplary embodiment of the assembly of the actuator.

FIG. 15 illustrates an exemplary embodiments of the armature/plunger assembly inside the actuator, which includes the a tube housing, a spring, and a coil of magnetic wire.

FIG. 16 illustrates an exemplary top blade and bottom blade for cutting an animal's nails.

FIG. 17 illustrate the blade assembly including a top blade and the lower blade located within the top frame.

FIG. 18 illustrates an exemplary cutting assembly including the actuator of the invention.

### DETAILED DESCRIPTION OF THE INVENTION

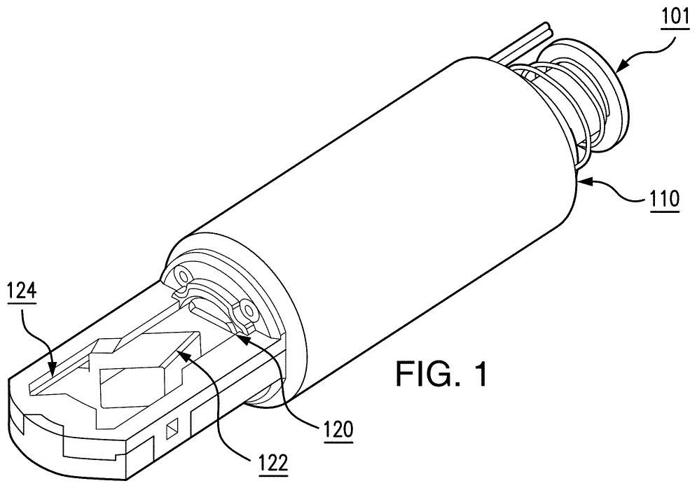

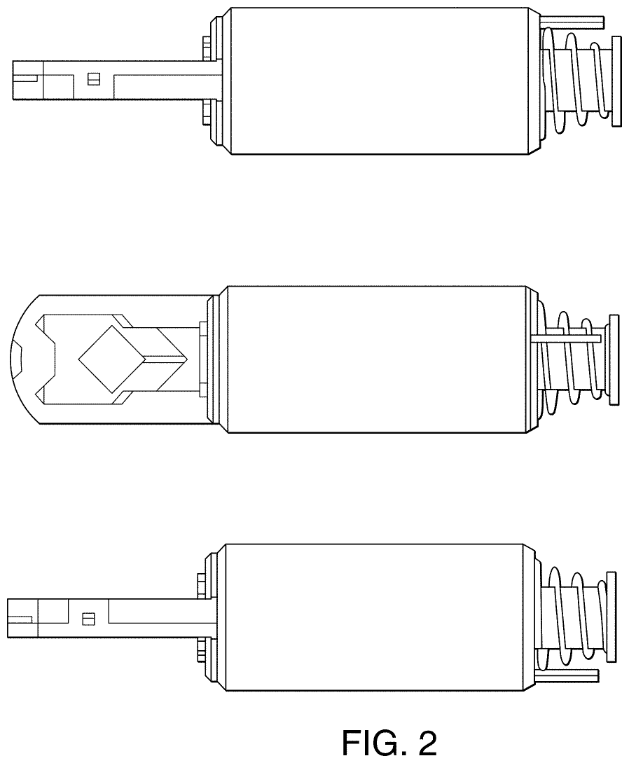

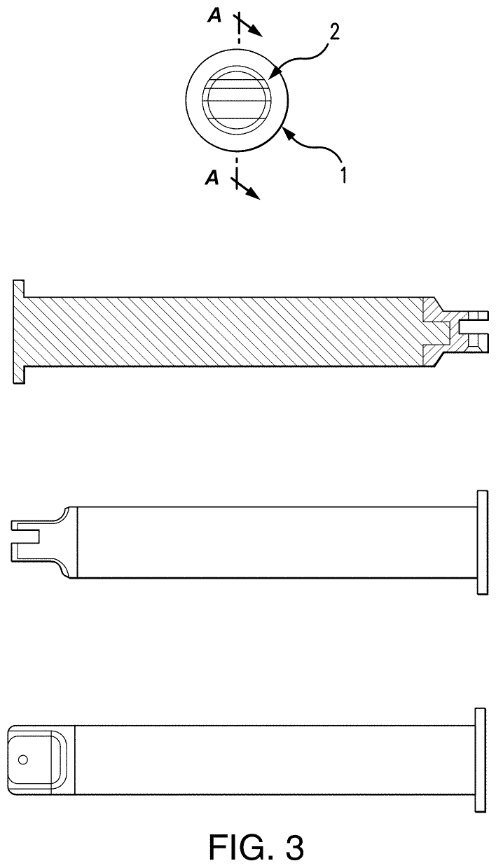

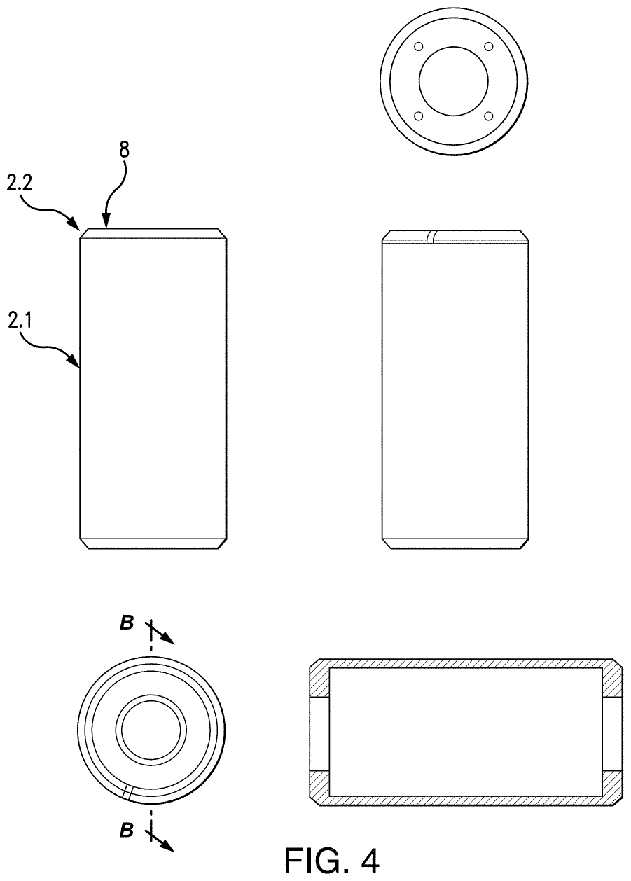

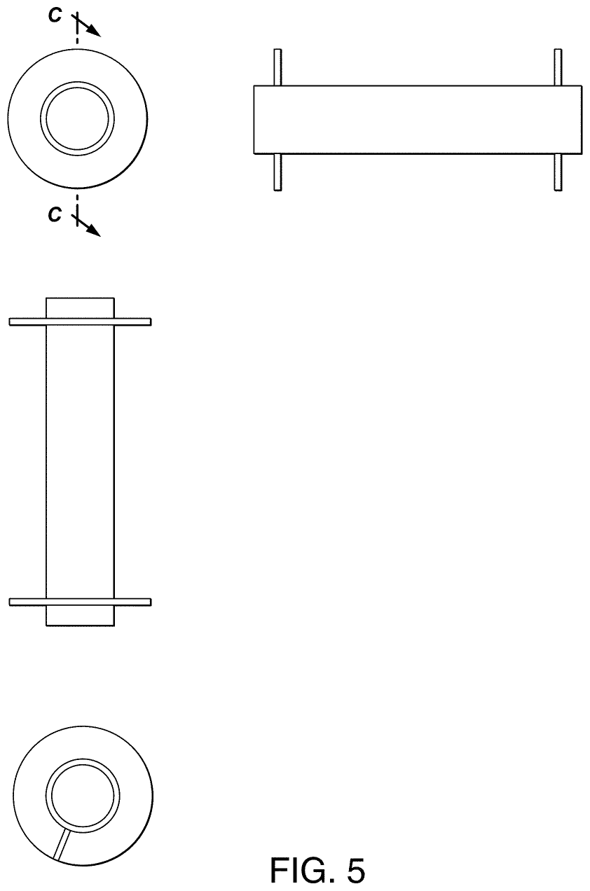

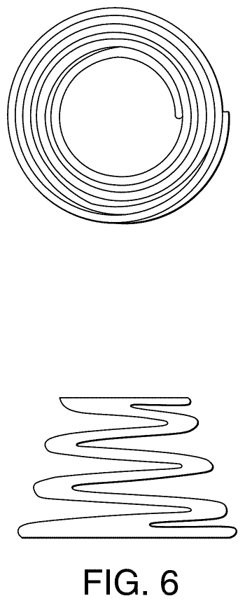

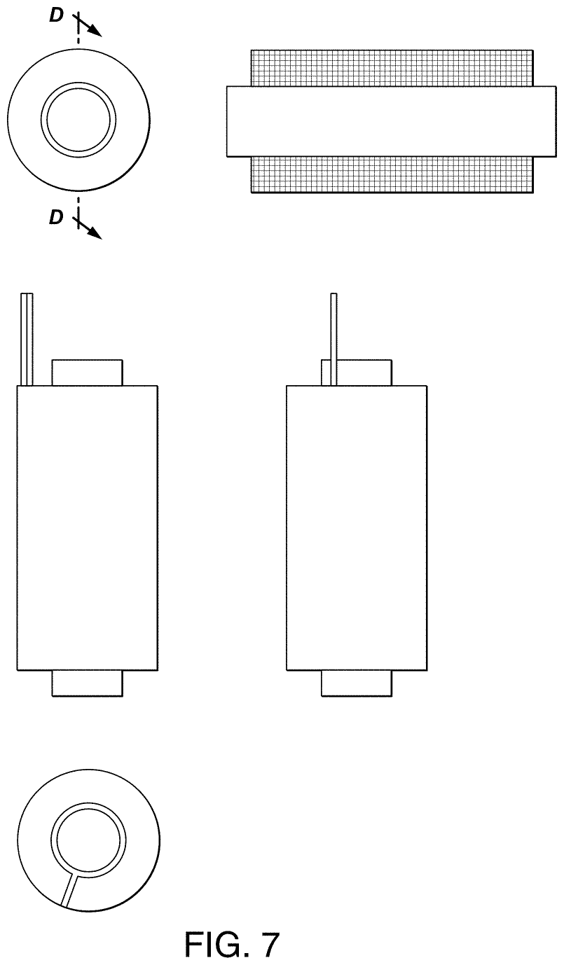

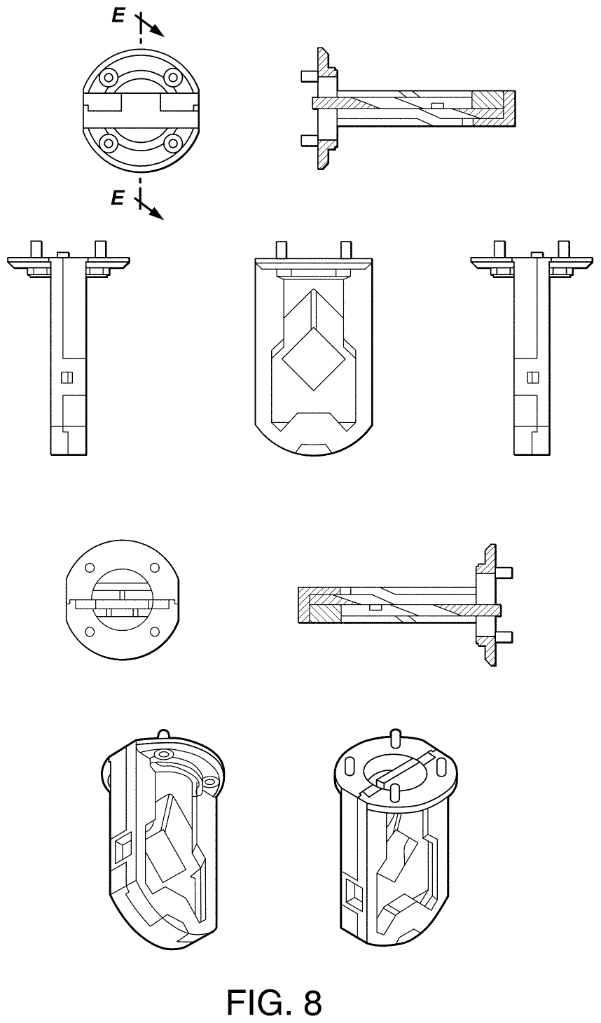

The MCA illustratively comprises a low-resistance actuator; and a linear blade assembly that is mounted to the top of the actuator. The MCA illustratively includes a low-resistance actuator (or solenoid); and a linear blade assembly that is mounted to the top of the actuator as shown in FIGS. 1-17. The present disclosure includes devices, systems, and methods for portable, battery-powered clipping arrangements. In various embodiments, intentionally over-driving the actuator to achieve a disproportionate amount of force for clipping an animal claw/nail relative to conventional actuator designs can provide simple and/or convenient clipping. In one example, operating the actuator/solenoid at the battery and/or actuator/solenoid peak-achievable “inrush current”, for a short duration, as opposed to operation at a controlled or the steady state current of the solenoid as in conventional actuator/solenoid operation, can provide preferable actuator/solenoid force and operation for clipping. The terms “actuator” and “solenoid” are used interchangeably herein.

Inrush current can be described, for explanation purposes, as the maximal solenoids, the inrush current can be multiple times larger than its rated current when first energized. If a lithium-ion battery is used to energize (e.g., electro-magnetic) a low-resistance solenoid, directly, during the first moments of solenoid energization the battery would discharge current similar to a short-circuit discharge. Such occurrence might be most observable in application with little or no protective circuitry between the power source and the solenoid. If this solenoid energization is not controlled: (i) the solenoid can heat up, can lose performance, and/or could become damaged; and/or (ii) the lithium-ion battery can heat up, swell, become damaged, and/or could vent and/or ignite instantaneous input current drawn by an electrical device when first turned on.

In certain embodiments, the MCA of the invention is designed to operate differently from conventional actuators/solenoids, for example, to provide purposeful operation using inrush current (and at the peak of current), as opposed to steady state current values. This can provide a greater influx of power to the solenoid, a stronger magnetic field, and hence a larger amount of power output.

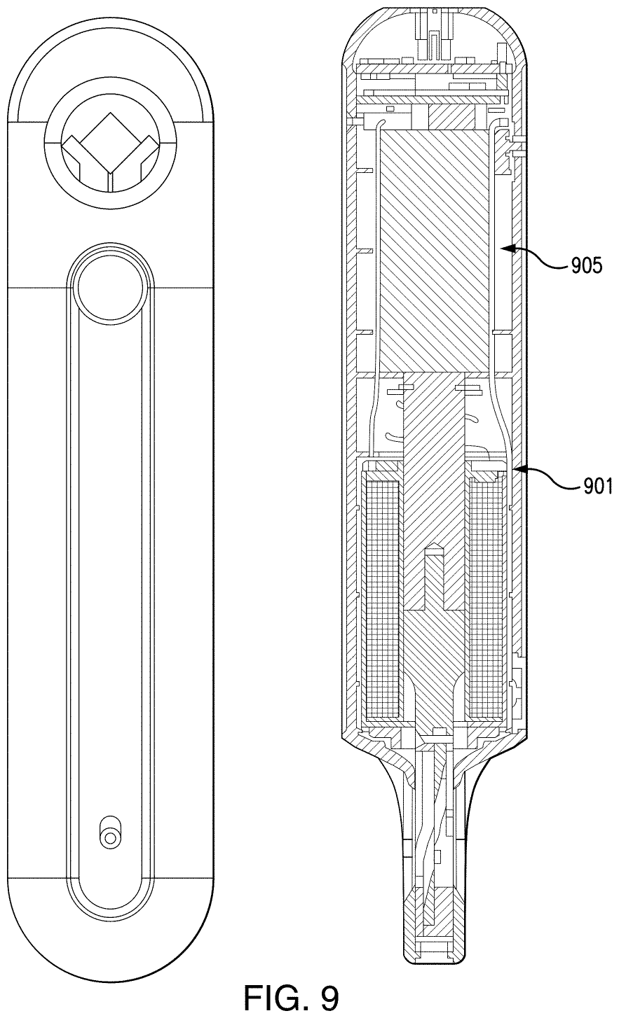

The present disclosure includes devices, systems, and methods for portable, battery-powered clipping of an animal's nails that includes a sensor to avoid cutting the nail too low and injuring or hurting the animal. As illustrated in FIG. 1, the invention includes a mechanical cutting actuator (MCA). The MCA includes a plunger (101) located in a tube housing (110), a cutting assembly (120) including a top blade (122) and a lower blade (124). The top blade and lower blade is comprised of a cutting material including steel, tungsten carbide, or any other metal material suitable for a cutting blade (e.g., CPM 3V Heat Treated or Tungsten Carbide or cr12mov). As illustrated in FIG. 9, the cutting device includes an internal cutting actuator (901) that includes a rechargeable battery (905), for example, a lithium-polymer battery (LiPo) that uses a solid polymer for the electrolyte and lithium for one of the electrodes.

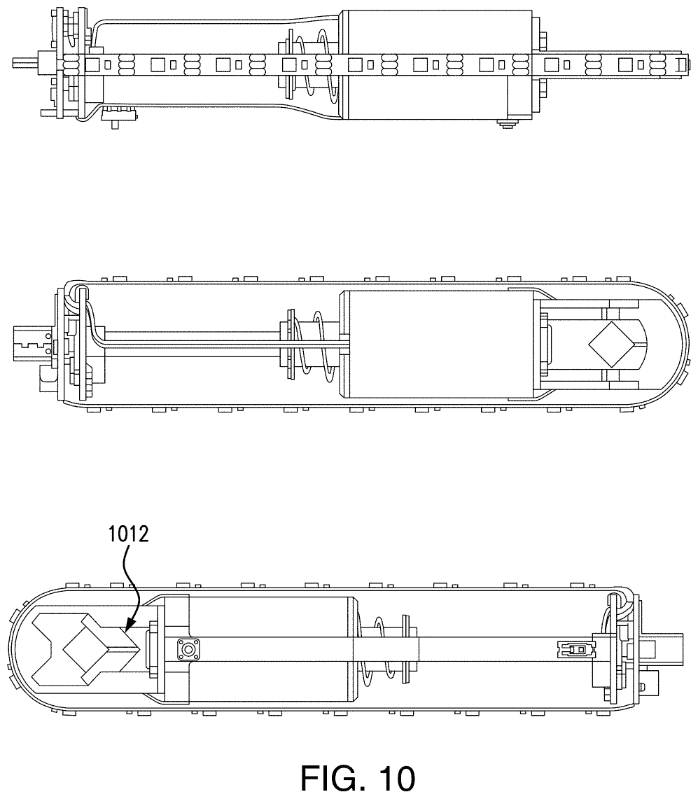

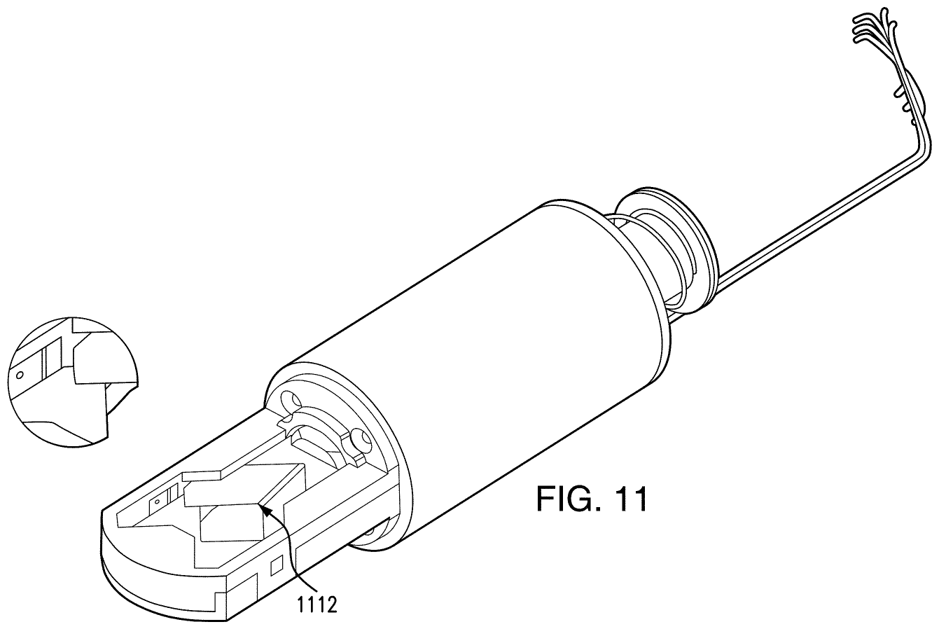

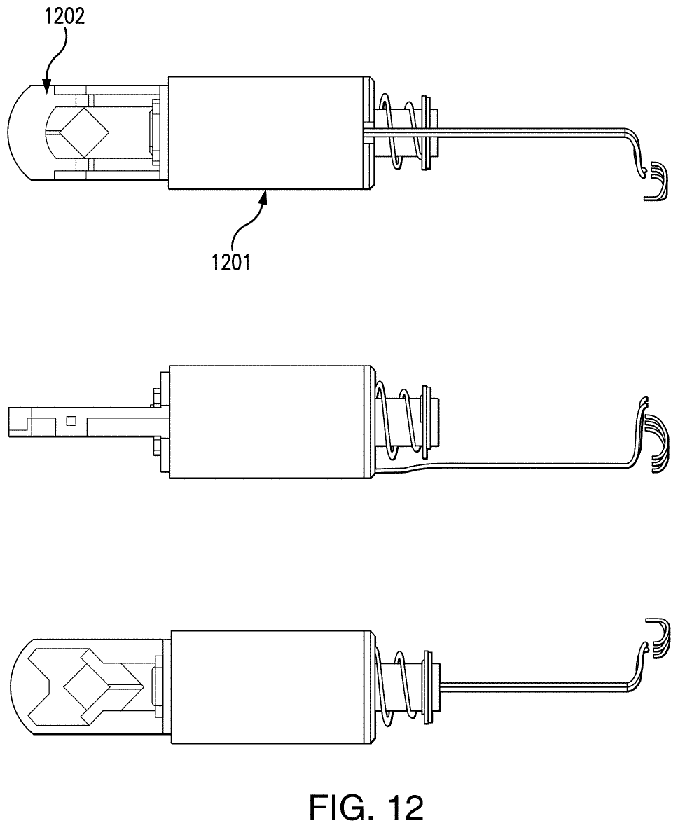

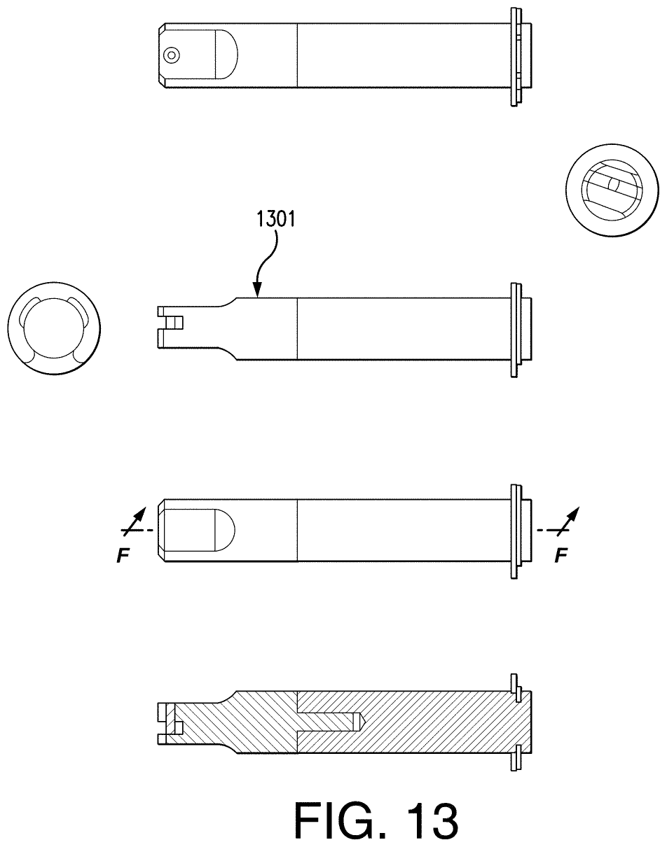

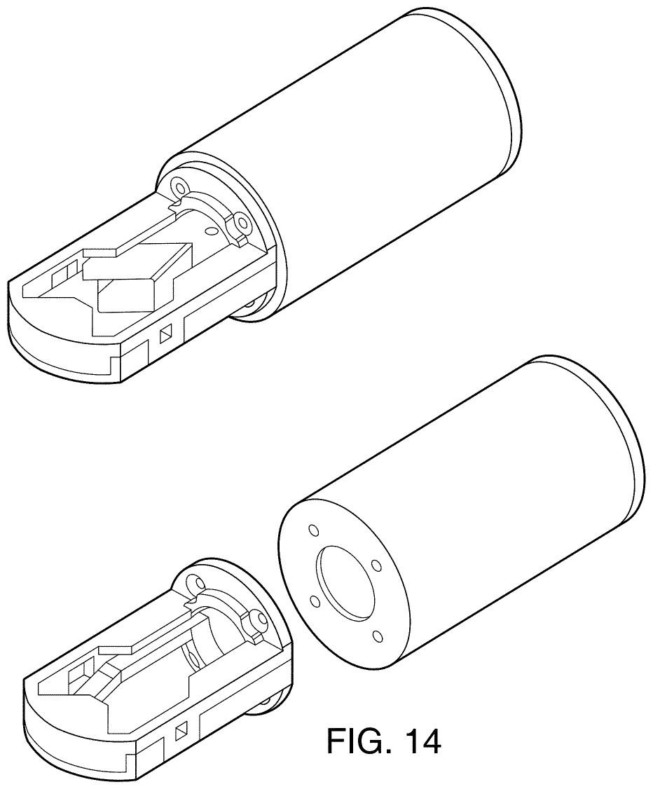

FIG. 10 illustrates a cutting device further illustrating the cutting assembly (1012). FIG. 11 illustrates the actuator located inside the cutting device, which includes the cutting assembly (1112) including a top cutting blade and a bottom cutting blade. In certain embodiments, one of the top or bottom blades is attached to the actuator assembly and in a fixed position. In another embodiment, one of the top or bottom blades is attached to the armature plunger and is movable when the armature is actuated. FIGS. 12 and 13 illustrate exemplary embodiments of the actuator (1201) and cutting assembly (1202) and armature (1301) (i.e., plunger), respectively. FIG. 14 illustrates an exemplary embodiment of actuator.

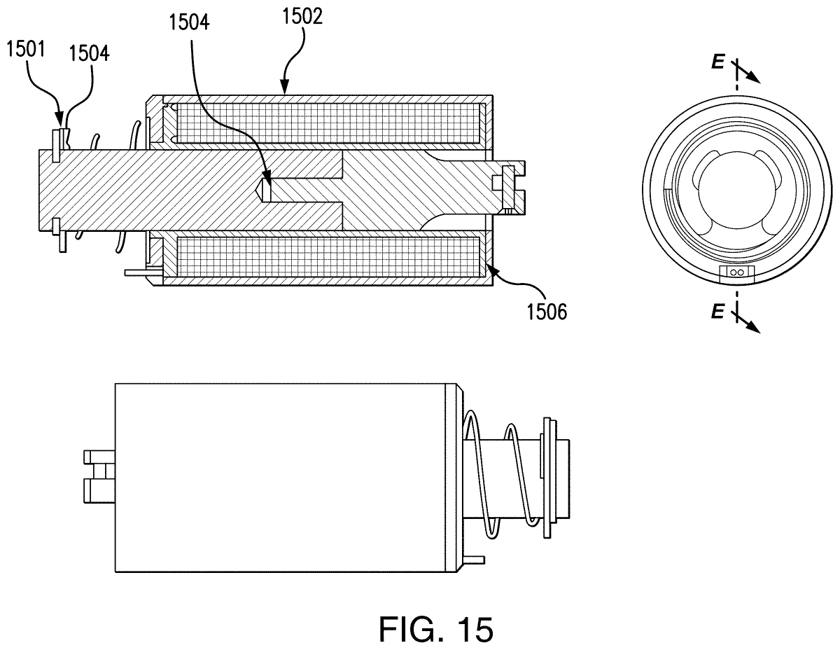

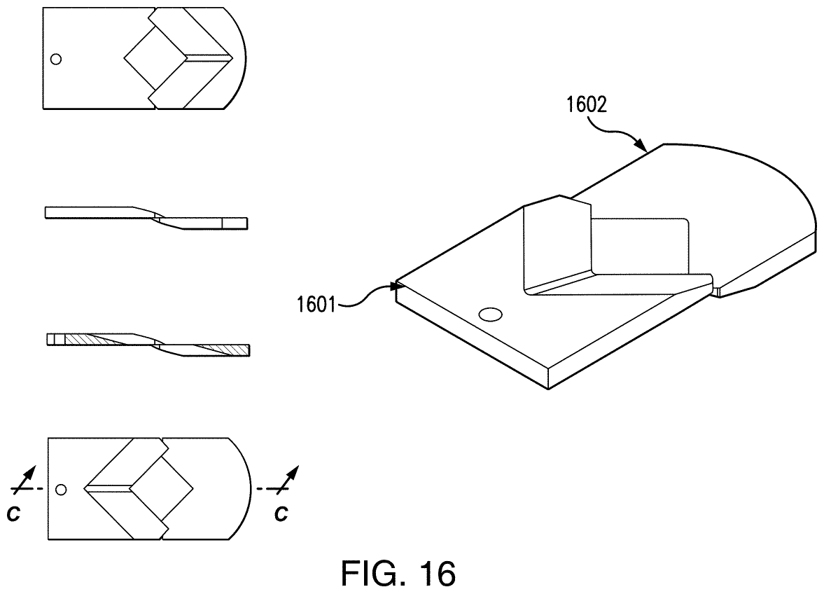

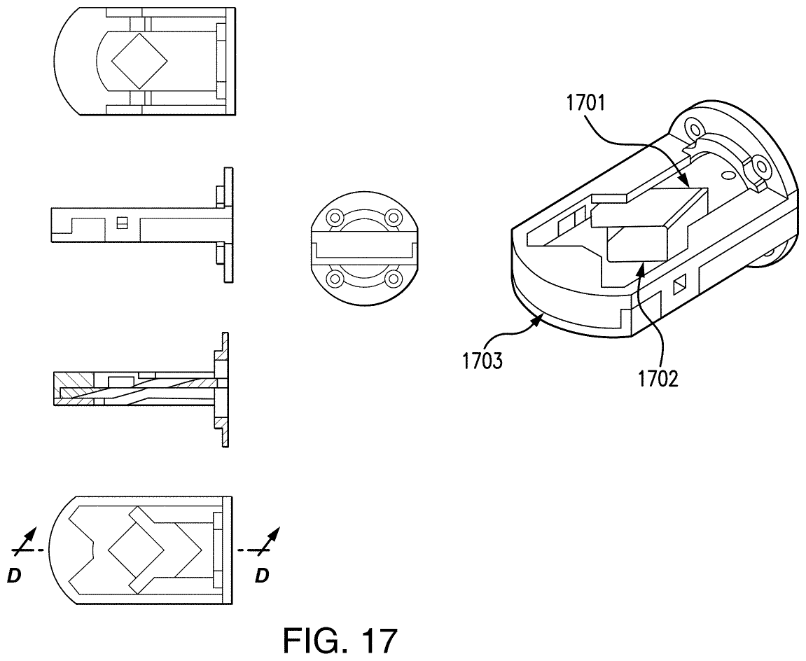

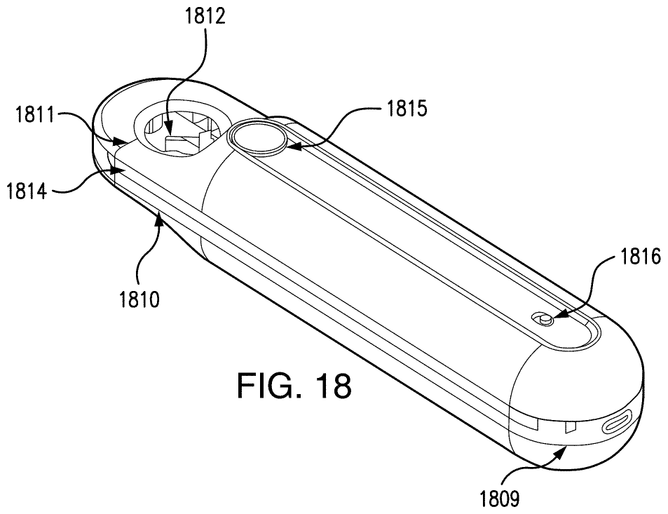

FIG. 15 illustrates an exemplary embodiments of the plunger assembly (1501) inside the actuator, which includes the a tube housing (1502), a spring (1504), and a coil of magnetic wire (1506). FIGS. 16 and 17 illustrate the blade assembly including a top blade (1601 and 1701), the lower blade (1602 and 1702) located within the top frame (1703) and bottom frame (1704). FIG. 18 illustrates an exemplary cutting assembly including a front plate (1811) and back plate (1810), the cutting assembly (1812), a cutting switch (1815), and on/off switch (1816), a light rail (1809), with an LED strip (1814).

In various embodiments of the disclosure, intentionally over-driving the actuator to achieve a disproportionate amount of force for clipping an animal's claw/nail relative to conventional actuator designs can provide simple and/or convenient clipping. In one illustrative example, operating the actuator at the battery and/or actuator peak-achievable “inrush current” for a short duration, as opposed to operation at a controlled or the steady state current of the actuator as in conventional actuator operation can provide preferable actuator operation for clipping.

As used herein, inrush current can be described, for explanation purposes, as the maximal instantaneous input current drawn by an electrical device when first turned on. In the case of actuators, the inrush current can be multiple times larger than its rated current when first energized. If a lithium-ion battery is used to energize (electro-magnetic) a low-resistance actuator, directly, during the first moments of actuator energization the battery would discharge current similar to a short-circuit discharge.

Such occurrence might be most observable in application with little or no protective circuitry between the power source and the actuator. If this actuator energization is not controlled: (i) the actuator can heat up, can lose performance, and/or could become damaged; and/or (ii) the lithium-ion battery can heat up, swell, become damaged, and/or could vent and/or ignite. Often, electronic circuit designs have the objective of limiting the current (i.e., inrush or “over-current” conditions), either intentionally or inherent.

In various embodiments, the MCA of the invention is designed to operate differently from conventional actuators, for example, to provide purposeful operation using inrush current (and at the peak of current), as opposed to steady state current values. This can provide a greater influx of power to the actuator, a stronger magnetic field, and hence a larger amount of power output.

In certain embodiments, the MCA can avoid the problem of damage to electrical components by limiting the duration of the inrush current pulse by using an electronically controlled switch, such as a MOSFET, that is enabled for a short duration, less than 25 ms, by a timing device, such as a microprocessor, between the battery or power supply and the actuator. The circuit between the battery supply and the MCA is briefly closed (approximately 10-25 ms), or just long enough to deliver peak inrush current to power the actuator. In various embodiments, the circuit between the battery supply and the MCA is briefly closed for about 5 milliseconds (ms), about 6, about 7, about 8, about 9, about 10, about 11, about 12, about 13, about 14, about 15, about 16, about 17, about 18, about 19, about 20, about 21, about 22, about 23, about 24, about 25, about 30, about 35, about 40, about 45, or about 50 ms.

However, in certain embodiments, the MCA of the invention is designed to limit the duration of current to avoid damage to the electronic system. The power and force applied during this period is approximately three to four times what can be produced if the actuator fired at a steady state current value, as is typical for conventional actuators.

This distinct “over-driving” of the actuator can enable ease and/or convenience in clipping, for example, by providing desirable clipping force in compact, portable design. Without such designs, a actuator of similar size would only provide approximately 2-4 lbs. of force, in comparison to the preferred about 10 to about 15 lbs. of force measured with the MCA, as suggested in Table 1.

TABLE 1

| | MCA | MCA | ODM | MCA | MCA | MCA | MCA | MCA | MCA | |
|---|---|---|---|---|---|---|---|---|---|---|
| | 1.03 mm | .84-20 | .69-21 | .78-21 | .70-22 | .59-23 | .53-24 | .45-27 | .14-34 | |
| | 19 AWG | AWG | AWG | AWG | AWG | AWG | AWG | AWG | AWG | OEM 38 |
| Power supply V | 3 | 3.8 | 4.5 | 7.6 | 17.6 | 21 | 26.8 | 36.8 | 125.5 | 46 |
| Power supply amps | 10 | 10 | 10 | 10 | 9.8 | 10 | 8 | 5.5 | 0.4 | 2.5 |
| Mod ODM- | 7.6 | 8.8 | 9.7 | 10.5 | | 11.8 | 11.9 | 11.9 | 9.2 | 24.7 |
| Power supply LB | | | | | | | | | | |
| Gen 1-MCA LB | 5.2 | 5.7 | | 6.6 | 7.6 | | | | | |
| Gen 2-MCA LB | 9.9 | 10.6 | | 11.1 | 12.2 | | | | | 17.2 lbs |
| “Current Design” | | | | | | | | | | |

In various embodiments, the actuator provides about 10 lbs of force (lbs), 11 lbs of force, 12 lbs-in of force, 13 lbs-in of force, 14 lbs-in of force, 15 lbs-in of force, 16 lbs-in of force, 17 lbs-in of force, 18 lbs-in of force, 19 lbs-in of force, 20 lbs-in of force, 22 lbs-in of force, 24 lbs-in of force, 26 lbs-in of force, 28 lbs-in of force, 30 lbs-in of force, or 35 lbs-in of force.

In comparison to conventional actuators, the MCA can produce “oversize” force from a smaller actuator, which is tuned or particularly desirable for clipping (i.e., a small, portable, hand-held pet nail clipper that operates on battery power).

In various embodiments the actuator of the invention has a miniature size of less than about 3 inches, about 2.9, about 2.8, about 2.7, about 2.6, about 2.3, about 2.2, about 2.1, about 2.0, about 1.9, about 1.8, about 1.7, about 1.6, about 1.5, about 1.4, about 1.3, about 1.2, about 1.1, about 1.0, about 0.9, about 0.8, about 0.7, about 0.6, or about 0.5 inches in length.

In certain embodiments, the MCA of the invention can produce an oversized magnetic field that fully-engulfs the rod/plunger within the actuator, which then drives or “throws” that rod forward at “heavy” speeds (e.g., snap action speeds).

In various embodiments, the actuators of the invention have a unique construction which allows easy transition from snap action to rest position. Using the same power, starting force is three to five times higher than standard actuators at the fully deenergized position. This is advantageous for starting inertial loads or detented mechanisms, and for conserving electrical power. Table 2 illustrates how the actuators of the invention in the de-energized and energized position.

The snap action actuators of the invention move to the end of the stroke within milliseconds with a characteristic increase in ending force and acceleration. This provides accurate, repeatable action.

Other embodiments of the MCA include:

Rod/coil size ratio: can include very large difference in size ratio, between the rod and the coil of the MCA's actuator. The coil can be about 6× bigger than the rod, which means that the forces come mainly from the magnetic field that is generated from the inrush current;

Magnet-assisted recoil: the MCA can be designed not to have a full stopping point, but instead to spring back, using the magnetic force generated during the influx of power from the battery's inrush current to the actuator.

(Optional) Singular structural design: Unlike conventional actuators, the MCA's plunger can be arranged without having a mounting thread. Instead the blade assembly can be mounted directly to the MCA's actuator, thereby becoming a single structural element of the cutting assembly;

Metallurgy and structure: In various embodiments, the actuator design incorporates steel, cobalt and/or iron alloys with high density, strength, and magnetic properties. Additionally, the frame of the MCA's actuator is reinforced (thicker) in the back, therefore directing all the magnetic force forward, like a rocket.

In an illustrative embodiment, the MCA of the invention has the following characteristics set forth in Table 3.

TABLE 3

| | |
|---|---|
| Stroke | Up to about 0.5″ |
| Attributes | Battery Powered |
| | High speed |
| | Long life |
| | Quiet performance |
| Max. Power Output | About 30 lbs. |
| Housing | Completely enclosed |
| Operational | Snap action |
| Characteristics | Quiet operation |
| | 5-10 times the starting |
| | force as conventional actuators |
| | Push model |
| Life (millions of cycles) | Over 1 million |
| Size | Length about 0.5″ to about 2″ |

In various embodiments, the MCA includes a clipping arrest system for stopping movement of the blade to prevent accidental clipping. In the illustrative embodiment, the clipping arrest system includes the blade configured as a sensor. The system is arranged in electrical communication with the blade via one or more electrical feeds, which collectively define an electrical path for flow of current. In an illustrative embodiment, a processor can operate communication circuitry to provide and monitor current through the electrical path including the blade. When non-nail material contacts the blade, the current through the blade is disturbed. For example, although the nail may be partly conductive itself, skin and/or the quick has greater conductance and can disturb the electrical path (e.g., voltage and/or current) through the blade to a detectable degree. Thus, contact between the nail and the blade can be distinguished from contact between the quick and the blade. In the illustrative embodiment, the processor receives indication of the disturbance in the electrical path from the communication circuitry and determines whether non-nail material has contacted the blade.

Responsive to determination that non-nail material (e.g., the animal's quick) has contacted the blade, the control system may arrest clipping. In the illustrative embodiment, the control system arrests the actuator by stopping actuation power to the actuator, responsive to determination that non-nail material has contacted the blade. In some embodiments, the control system 62 may arrest clipping by powered activation of the actuator to drive the blade to the withdraw position. In some embodiments, the control system may arrest clipping by activation of an arrest actuator (e.g., lock) to block further movement of the blade 24 towards the clipping position. In such embodiments, the arrest actuator and/or actuator may be configured to act with quick response time (e.g., less than 0.1 sec) to arrest the blade from clipping. Accordingly, upon contact of between the subject's quick and the blade, clipping can be arrested to prevent further and/or more extensive engagement of the blade with non-nail material, such as the quick or digit of the appendage, which could lead to injury.

Responsive to determination that non-shell material has contacted the blade, the control system may operate the indicator to indicate no clipping is available. For example, the indicator can be de-illuminated or illuminated with red color. In some embodiments, the control system may operate the indicator to indicate clipping arrest by distinct warning, such as by flashing three times.

Within the present disclosure, the advantage of applying short duration inrush current can be realized for particular benefit in the animal nail clipping. For example, by taking advantage of the unique inrush phenomenon, a brief but significant driving force can be applied to the clipping blade, providing a desirably compact but powerful arrangement that is particularly advantageous for handheld clipping. Such arrangements can relieve stress in the clipping process for both user and subject.

Additional features, which alone or in combination with any other feature(s), including those listed above and those listed in the claims, may comprise patentable subject matter and will become apparent to those skilled in the art upon consideration of the above description of embodiments exemplifying the invention as presently perceived.

What is claimed is:

1. An animal nail clipper, comprising:
a body for grasping by a user's hand, the body defining a clip space as a receptacle for insertion of an animal's nail for clipping,
at least one blade coupled with the body for movement between a withdraw position retracted from the clip space and a clip position extended into the clip space for clipping, and
a clipping actuator system comprising a actuator and a blade frame coupled with the actuator to receive the at least one blade secured with the actuator for movement between the withdraw and clip positions.

2. The animal nail clipper for claim 1, wherein the actuator is configured to receive inrush current from a power source for overdriving the actuator to drive the at least one blade to the clip position from the withdraw position.

3. The animal nail clipper of claim 2, further comprising a clipping control system for controlling duration of inrush current to the actuator.

4. The animal nail clipper of claim 3, wherein the clipping control system controls the duration of inrush current to the actuator within a range of about 10 to about 25 ms.

5. The nail clipper of claim 1 comprising an outer housing; an actuator located within the outer housing and comprising an actuator inner housing; a plunger extending therefrom; and a blade attached to the plunger capable of moving between a ready position and a driven position; the plunger being coupled to the body for imparting reciprocating translation to the body in response to activation and deactivation of the actuator; wherein the actuator provides a force of 10 or more lbs of force.

6. The nail clipper of claim 1, wherein the plunger further includes an arm, and wherein the arm couples the plunger to the body for translation therewith.

7. The nail clipper of claim 1, further comprising a spring biasing the plunger to an extended position.

8. An actuator comprising a actuator housing and a plunger extending therefrom, the plunger being coupled to an armature for imparting reciprocating translation to the armature in response to activation and deactivation of the actuator, wherein the armature reciprocates along a first axis, and wherein the plunger defines a second axis that is parallel with the first axis and wherein the actuator provides a force of at least 10 lbs.

9. The actuator of claim 8, further comprising a spring biasing the plunger to an extended position.

10. The actuator of claim 8, further comprising a bracket clamping the actuator housing to the plunger.

11. The actuator of claim 8, further comprising a plate, wherein the plate couples the plunger to the arm for translation therewith.

12. A nail clipper device comprising an actuator comprising an actuator body comprising an armature comprising a cutting assembly,
wherein the cutting assembly comprises a top blade and a bottom blade, and
wherein the actuator includes a coil, which receives power from one or more batteries.

13. The nail clipper of claim 12, further comprising a sensor and processor that activate the actuator to engage in cutting.

14. The nail clipper of claim 12, wherein the one or more batteries is a lithium polymer battery.

15. The nail clipper of claim 12, wherein the actuator is inside the nail clipper device.

16. The nail clipper of claim 12, wherein the actuator activates the armature with at least 10 pounds of force.

17. The nail clipper of claim 12, wherein the actuator activates the armature with at least 15 pounds of force.
